(19) United States
(12) Patent Application Publication
(10) Pub. No.: US 2006/0115150 A1
(43) Pub. Date: Jun. 1, 2006

(54) Calculation method of a cumulative histogram

(76) Inventors: Olivier Gay-Bellile, Paris (FR); Laurent Pasquier, Asnieres Sur Seine (FR)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/517,285

(22) PCT Filed: Jun. 5, 2003
(86) PCT No.: PCT/IB03/02546

§ 371 Date: Dec. 8, 2004

(30) Foreign Application Priority Data
Jun. 11, 2002 (FR) 02 07 153

(51) Int. Cl. G06K 9/00

(52) U.S. Cl. 382/168

(57) ABSTRACT

The invention relates to a calculation method of a cumulative histogram. Such a method comprises calculation stages in which at least two additions are used in parallel. Each addition permits to calculate an addition result. The additions are made either with two histogram values or with one histogram value and one addition result calculated during a previous calculation stage, or with two addition results calculated during one or two previous calculation stages.

### FIELD OF THE INVENTION

The present invention relates to a method of calculating cumulative histogram values from N histogram values.

It also relates to a calculation circuit for implementing such a method.

The invention finally relates to a program comprising program code instructions for the execution of the stages of this method.

The invention finds an application, for example, in an image processing system notably in a real-time system.

### BACKGROUND OF THE INVENTION

Many image processing methods utilize cumulative histograms. This is the case, for example, with thresholding methods or segmenting methods frequently used in image processing systems.

An image conventionally comprises pixels which have pixel values, for example, a gray level, a chrominance value or a luminance value. These pixel values are situated in a value interval, for example, between 0 and 255 for the gray levels. A histogram represents the number of pixels of the image that have a given pixel value. For each pixel value a histogram thus has a histogram value equal to the number of pixels that have this pixel value. FIG. 1 shows an example of a histogram for an image of 64 pixels, which may adopt pixel values between 0 and 7. In this image 5 pixels have the 0 value, 10 have the 1 value and so on.

Based on a histogram it is possible to calculate a cumulative histogram. A cumulative histogram represents the number of pixels of the image that have a value smaller than or equal to a given pixel value. For each pixel value a cumulative histogram thus has a cumulative histogram value equal to the number of pixels that have a value smaller than or equal to this pixel value. FIG. 2 shows the cumulative histogram calculated from the histogram of FIG. 1. It is found that for example 57 pixels have a pixel value smaller than or equal to 5.

In a conventional way the calculation of the cumulative histogram values from histogram values is made in an iterative fashion by adding to each iteration the histogram value that corresponds to this iteration to the cumulative histogram value obtained from the previous iteration. While taking up the example of FIGS. 1 and 2, the cumulative histogram value that corresponds to the pixel value 0 is taken to be equal to the histogram value that corresponds to the pixel value 0. During a first iteration the histogram value that corresponds to the value 1 is added to the cumulative histogram value that corresponds to the value 0. In this way the cumulative histogram value that corresponds to the value 1 is obtained. During a second iteration the histogram value that corresponds to the value 2 is added to the cumulative histogram value that corresponds to the value 1, calculated in the previous iteration. In this way the cumulative histogram value that corresponds to the value 2 is obtained. One proceeds in like manner to obtain all the cumulative histogram values.

FIG. 3 diagrammatically shows operations which permit to utilize such an iterative calculation of a cumulative histogram. This example is applied to a histogram having 8 values which are stored in 8 registers 300 to 307. Eight other registers 310 to 317 permit to store the cumulative histogram values calculated during seven stages 31 to 37 by an adder 3.

The histogram value that corresponds to the 0 pixel value and is stored in the register 300 is copied in the register 310. Then, during the first stage 31, the adder 3 adds the histogram value that corresponds to the pixel value 1 and is stored in the register 301 to the cumulative histogram value stored in the register 310. The result obtained is then stored in the register 311 and corresponds to the cumulative histogram value that corresponds to the pixel value 1. During the second stage 32, the adder 3 adds the histogram value that corresponds to the pixel value 2 and is stored in the register 302 to the cumulative histogram value stored in the register 311. The result obtained is then stored in the register 312 and corresponds to the cumulative histogram value that corresponds to the pixel value 2. One proceeds in like manner to obtain all the cumulative histogram values.

It is found that such a cumulative histogram calculation by means of an adder requires seven stages. In a general way a cumulative histogram calculation comprising N values needs to have (N-1) stages. Consequently, such a calculation requires a considerable processing time. This is a drawback notably in real-time image processing systems, in which there are limits to processing time.

### SUMMARY OF THE INVENTION

It is an object of the invention to propose a method of calculating a cumulative histogram requiring little processing time.

A calculation method according to the invention and as defined in the opening paragraph is characterized in that it comprises calculation stages which use at least two parallel additions, each addition in a calculation stage leading to an addition result based on two histogram values or one histogram value and an addition result calculated during a previous calculation stage, or two addition results calculated during at least one previous calculation stage.

The invention utilizes the fact that a cumulative histogram value that corresponds to a given pixel value, is the sum of the histogram values that correspond to the pixel values that are lower than or equal to this given pixel value. There are various methods of calculating a sum of values from additions made with two data. For example, the iterative method used in the prior-art calculation method comprises adding during an iteration the value that corresponds to this iteration to the sum of values obtained from the previous iteration. Another method comprises, for example, adding the values in pairs, in parallel, and adding the results obtained two by two together until the desired sum value is obtained.

According to the invention certain additions are made in parallel during a same calculation stage. Hence, the number of calculation stages is reduced compared to the prior art. Consequently, the processing time necessary for implementing the method according to the invention is shorter than the processing time necessary in the prior art.

In an advantageous embodiment of the invention the calculation method comprises at least two successive series of calculation stages, each series of calculation stages being intended to calculate cumulative histogram values that correspond to a group of histogram values that includes a number of histogram values that is strictly lower than N.

According to this advantageous embodiment it is possible to reduce the number of additions made in parallel during a calculation stage while maintaining a short processing time. This embodiment is particularly advantageous if the number of histogram values is high. Furthermore, if the method according to the invention is utilized by a circuit comprising registers for storing addition results, this advantageous embodiment permits to reduce the number of registers required, as will be seen hereinafter.

The invention also relates to a calculation circuit for calculating cumulative histogram values from histogram values, said circuit comprising at least two adders which are capable of carrying out additions in parallel during calculation stages, each addition during a calculation stage leading to an addition result based on two histogram values, or one histogram value and one addition result calculated during a previous calculation stage, or two addition results calculated during at least one previous calculation stage.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 represents an example of a histogram;

FIG. 2 represents a cumulative histogram calculated from the histogram of FIG. 1;

FIG. 3 represents in a diagram a prior-art method of calculating the cumulative histogram of FIG. 2;

FIG. 4 represents in a diagram a first example of a method according to the invention;

FIG. 5 represents in a diagram a second example of a method according to the invention;

FIG. 6 represents a circuit for implementing the method shown in FIG. 5; and

FIG. 7 represents in a diagram a method according to an advantageous embodiment of the invention.

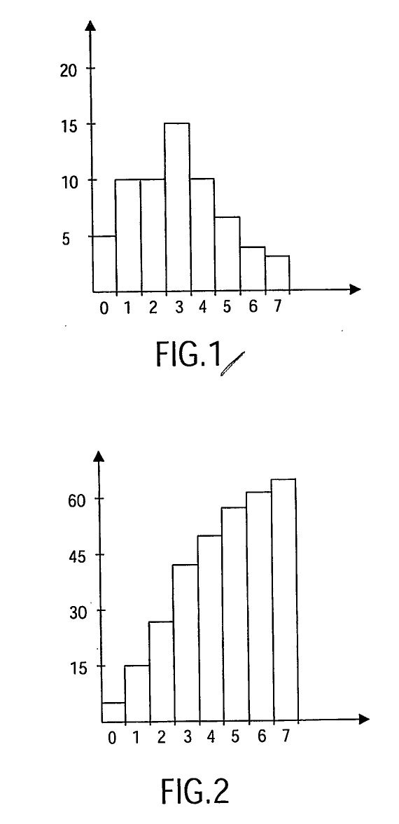

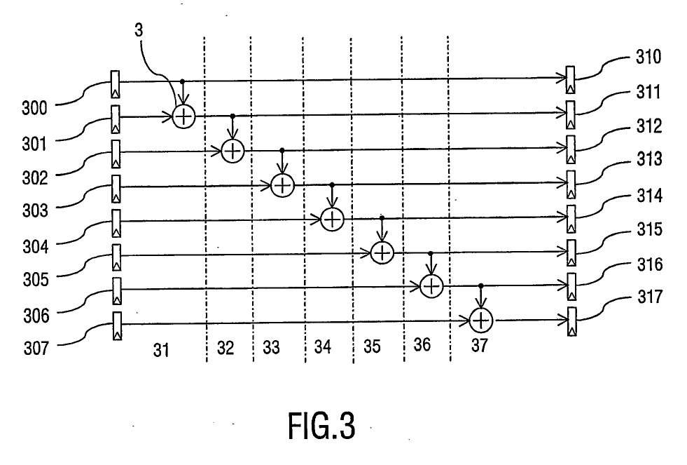

### DESCRIPTION OF PREFERRED EMBODIMENTS

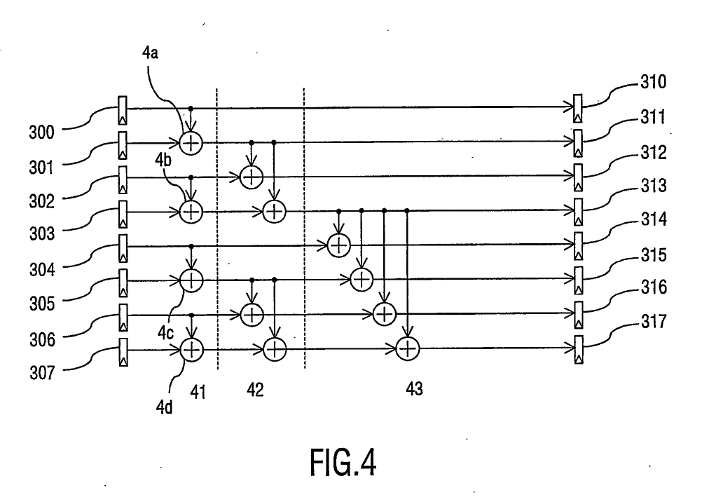

FIG. 4 illustrates a method of calculating a cumulative histogram according to the invention, based on eight histogram values. Such a method is executed by four adders 4a to 4d carrying out additions in parallel during three stages 41 to 43. The histogram values are stored in eight registers 300 to 307 and the cumulative histogram values calculated with this method are stored in eight other registers 310 to 317.

During the first stage 41, a first adder 4a makes a first addition of the histogram value that corresponds to the pixel value 0 and the one that corresponds to the pixel value 1, stored in the registers 300 and 301, respectively. The cumulative histogram value that corresponds to the pixel value 1, is accordingly obtained and stored in the register 311. In parallel, three other additions are made during this first stage 41, by a second adder 4b, a third adder 4c and a fourth adder 4d. The second adder 4b carries out the addition of the histogram value that corresponds to the pixel value 2 and the one that corresponds to the pixel value 3, the third adder 4c carries out the addition of the histogram value that corresponds to the pixel value 4 and the one that corresponds to the pixel value 5 and the fourth adder 4d carries out the addition of the histogram value that corresponds to the pixel value 6 and the one that corresponds to the pixel value 7. The results of these additions are stored in registers not shown in FIG. 4.

During the second stage 42 the first adder 4a makes the addition of the histogram value that corresponds to the pixel value 2 and the cumulative histogram value that corresponds to the pixel value 1, calculated during the preceding stage. The cumulative histogram value that corresponds to the pixel value 2 is accordingly obtained and stored in the register 312. In parallel, the second adder 4b carries out the addition of the cumulative histogram value that corresponds to the pixel value 1, and the sum of the histogram values that correspond to the pixel values 2 and 3, calculated during the preceding stage. The cumulative histogram value that corresponds to the pixel value 3 is accordingly obtained and stored in the register 312. In parallel, the third adder 4c carries out the addition of the histogram value that corresponds to the pixel value 6 and the sum of the histogram values that correspond to the pixel values 4 and 5, calculated during the previous stage. In parallel, the fourth adder 4d carries out the addition of the sum of the histogram values that correspond to the pixel values 4 and 5 and the sum of the histogram values that correspond to the pixel values 6 and 7.

During the third stage 43 the first adder 4a carries out the addition of the histogram value that corresponds to the pixel value 4 and the addition result calculated by the second adder 4b during the second stage 42, that is to say, the cumulative histogram value that corresponds to the pixel value 3. The cumulative histogram value that corresponds to the pixel value 4 is accordingly obtained and stored in the register 314. In parallel, the second adder 4b carries out the addition of the addition result calculated by the second adder 4b during the second stage 42 and the addition result calculated by the third adder 4c during the first stage 41. The cumulative histogram value that corresponds to the pixel value 5 is accordingly obtained and stored in the register 315. In parallel, the third adder 4c carries out the addition of the addition result calculated by the second adder 4b during the second stage 42 and the addition result calculated by the third adder 4c during the second stage 42. The cumulative histogram value that corresponds to the pixel value 6 is accordingly obtained and stored in the register 316. In parallel, the fourth adder 4d carries out the addition of the addition result calculated by the second adder 4b during the second stage 42 and the addition result calculated by the fourth adder 4d during the second stage 42. The cumulative histogram value that corresponds to the pixel value 7 is accordingly obtained and stored in the register 317.

By means of the method illustrated in FIG. 4 the calculation of a cumulative histogram based on eight histogram values requires three calculation stages instead of eight in the prior art. Consequently, the implementation of this method permits to considerably reduce the processing time necessary for the calculation of the cumulative histogram.

The method illustrated in FIG. 4 makes use of four additions in parallel to calculate the cumulative histogram based on eight histogram values. It is possible that the number of additions that may be made in parallel is limited. For example, if such a method is implemented by a circuit comprising adders, the number of adders is sometimes limited because the circuit surface reserved for the adders is limited. However, the method according to the invention may be implemented the moment when the circuit comprises at least two adders which are capable of performing additions in parallel.

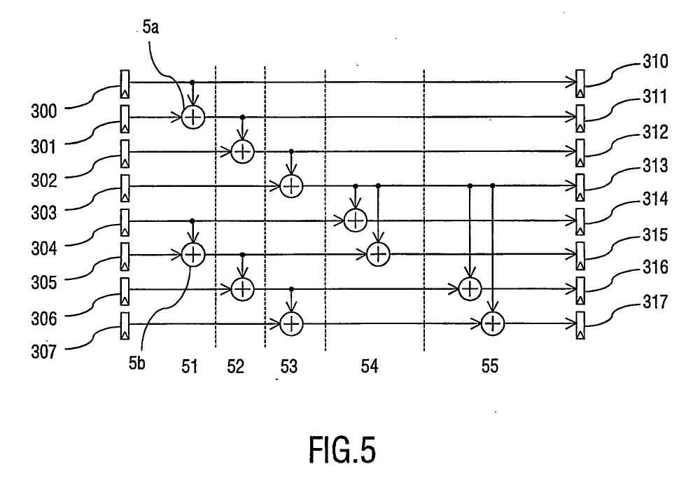

FIG. 5 illustrates another example of a method according to the invention for calculating a cumulative histogram based on eight histogram values, said method utilizing two additions in parallel.

Such a method is carried out by two adders 5a and 5b which perform additions in parallel during five stages 51 to 55. The histogram values are stored in eight registers 300 to 307 and the cumulative histogram values calculated with this method are stored in eight other registers 310 to 317.

During the first stage 51, the first adder 5a makes an addition of the histogram value that corresponds to the pixel value 0 and the one that corresponds to the pixel value 1, stored in the respective registers 300 and 301. The cumulative histogram value that corresponds to the pixel value 1 is accordingly obtained and stored in the register 311. In parallel, the second adder 5b makes an addition of the histogram value that corresponds to the pixel value 4 and the one that corresponds to the pixel value 5.

During the second stage 52, the first adder 5a makes an addition of the histogram value that corresponds to the pixel value 2 and the addition result calculated by the first adder 5a during the first stage 51. The cumulative histogram value that corresponds to the pixel value 2 is accordingly obtained and stored in the register 312. In parallel, the second adder 5b performs an addition of the histogram value that corresponds to the pixel value 6 and the addition result calculated by the second adder 5b during the first stage 51.

During the third stage 53, the first adder 5a makes an addition of the histogram value that corresponds to the pixel value 3 and the addition result calculated by the first adder 5a during the second stage 52. The cumulative histogram value that corresponds to the pixel value 3 is accordingly obtained and stored in the register 313. In parallel, the second adder 5b performs an addition of the histogram value that corresponds to the pixel value 7 and the addition result calculated by the second adder 5b during the second stage 52.

During the fourth stage 54, the first adder 5a performs an addition of the histogram value that corresponds to the pixel value 4 and the addition result calculated by the first adder 5a during the third stage 53. The cumulative histogram value that corresponds to the pixel value 4 is accordingly obtained and stored in the register 314. In parallel, the second adder 5b performs an addition of the addition result calculated by the first adder 5a during the third stage 53 and the addition result calculated by the second adder 5b during the first stage 51. The cumulative histogram value that corresponds to the pixel value 5 is accordingly obtained and stored in the register 315.

During the fifth stage 55, the first adder 5a performs an addition of the addition result calculated by the first adder 5a during the third stage 53 and the addition result calculated by the second adder 5b during the second stage 52. The cumulative histogram value that corresponds to the pixel value 6 is accordingly obtained and stored in the register 316. In parallel, the second adder 5b makes an addition of the addition result calculated by the first adder 5a during the third stage 53 and the addition result calculated by the second adder 5b during the third stage 53. The cumulative histogram value that corresponds to the pixel value 7 is accordingly obtained and stored in the register 317.

By means of the method illustrated in FIG. 5 the cumulative histogram calculation based on eight histogram values requires five calculation stages instead of eight from the prior art. Consequently, even with a limited number of additions which may be effected in parallel, it is possible to implement the method according to the invention for reducing the processing time necessary for the calculation of the cumulative histogram.

It should be observed that the method illustrated in FIG. 5 may be applied for a different number of histogram values and a different number of parallel additions. If it is assumed for the calculation of a cumulative histogram that one has A additions which may be made in parallel, A is an integer greater than or equal to 2. In order to apply a method which is identical with that described in FIG. 5, the N histogram values are divided into A groups of M values in the rising order of the pixel values. For example, in the method illustrated in FIG. 5, where N is 8, A is 2, there are thus 2 groups of 4 values, the first group comprising the histogram values that correspond to the pixel values 0 to 3, the second group to histogram values that correspond to pixel values 4 to 7.

If N is not a multiple of A, there are thus A groups of M values and one group of N-MA values. It will be assumed hereinafter that N is a multiple of A, the method can then easily be derived from that described hereinafter when one has an additional group of N-MA values.

A first stage comprises adding the first histogram value and the second histogram value of each group in parallel to obtain A cumulative histogram sub-values. In the first group the cumulative histogram sub-value thus calculated corresponds to the cumulative histogram value that corresponds to the pixel value 1.

A second stage comprises adding in parallel the third histogram value of each group to the cumulative histogram sub-value calculated for the same group during the previous stage.

One proceeds in identical manner for the fourth histogram values of each group and so on and so forth. Consequently, after the first stage, M-2 calculation stages are effected which each comprise adding in parallel, for each histogram value of each group, starting from the third histogram value, said value with the sum of values obtained in the preceding stage. These calculation stages lead to M-2 cumulative histogram sub-values in each group.

The stages described above correspond to an application of the cumulative histogram calculation method according to the prior art, said method being applied in parallel to each group.

One thus has cumulative histogram values that correspond to the histogram values of the first group, and cumulative histogram sub-values in the following groups.

During the next stage, the first histogram value and the A-1 first cumulative histogram sub-values of the second group are added in parallel to the cumulative histogram value that corresponds to the last histogram value of the first group. In this way the A first cumulative histogram values are obtained, which correspond to the A first histogram values of the second group.

During the next stage, the next A cumulative histogram sub-values of the second group are added in parallel to the cumulative histogram value that corresponds to the last histogram value of the first group.

One similarly proceeds until all the cumulative histogram values that correspond to the histogram values of the second group are obtained.

During the next stage the first histogram value and the A-1 first cumulative histogram sub-values of the third group are added in parallel to the cumulative histogram value that corresponds to the last histogram value of the second group, calculated during the preceding stage. In this way the A first cumulative histogram values that correspond to the A first histogram values of the third group, are obtained.

One then proceeds as described above until all the cumulative histogram values are obtained which correspond to the histogram values of the third group.

One proceeds in identical manner for the other groups until all the cumulative histogram values are obtained.

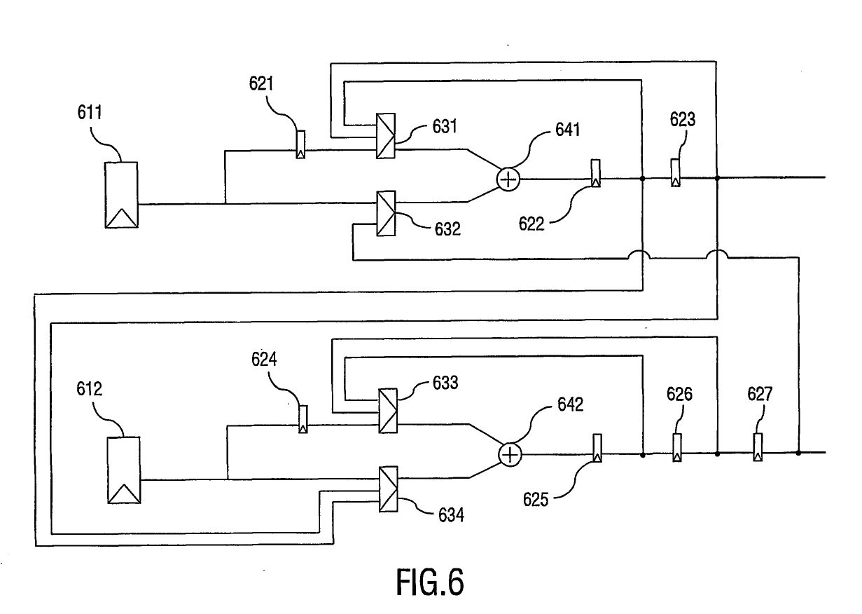

FIG. 6 represents a circuit which may be used for implementing a method according to the invention. Such a circuit comprises memories 611 and 612, temporary registers 621 to 627, multiplexers 631 to 634 and adders 641 and 642. This circuit may be used for implementing the method of FIG. 5 as will be explained hereinafter.

The memories 611 and 612 serve to store histogram values. These memories may be registers or register banks, for example.

During the first stage 51 the histogram value that corresponds to the pixel value 0 is sent from the first memory 611 to the first temporary register 621 then to the first multiplexer 631 and the histogram value that corresponds to the pixel value 1 is sent from the first memory 611 to the second multiplexer 632. These two values are selected by the multiplexers 631 and 632. For this purpose the multiplexers 631 and 632 are controlled by a control circuit not shown in FIG. 6. These two values are added together by the first adder 641 and the addition result obtained is stored in the second temporary register 622. In parallel, the second adder 642 similarly performs the addition of the histogram values that correspond to the pixel values 4 and 5, and the addition result is stored in the fifth temporary register 625.

The temporary registers 622 and 625 are connected to a storage device for storing cumulative histogram values, for example, registers 310 to 317 of FIG. 5. Hence, if during a calculation stage an addition result corresponds to a cumulative histogram value, the result is loaded in the storage device by means of another control circuit not shown in FIG. 6.

During the second stage 52, the first adder 641 is to perform the addition of the histogram value that corresponds to the pixel value 2 and the value stored in the second temporary register 622. The first multiplexer 631 thus selects the latter value for sending it to the first adder 641.

When an addition result is calculated by the first adder 641 or the second adder 642, it is stored in the second temporary register 622 or in the fifth temporary register 625, respectively. The value previously stored in one of these registers is then shifted to the next temporary register, that is to say, the third temporary register 623 or the sixth temporary register 626, respectively.

The addition result produced by the first adder 641 is thus stored in the second temporary register 622; the addition result calculated during the preceding stage is then stored in the third temporary register 623. In parallel, the second adder 642 performs the addition of the histogram value that corresponds to the pixel value 6 and the value stored in the fifth temporary register 625.

During the third stage 53, the first adder 641 performs the addition of the histogram value that corresponds to the pixel value 3 and the value stored in the second temporary register 622. In parallel, the second adder 642 performs the addition of the histogram value that corresponds to the pixel value 7 and the value stored in the fifth temporary register 625.

During the fourth stage 54, the first adder 641 performs the addition of the histogram value that corresponds to the pixel value 4 and the value stored in the second temporary register 622. In parallel, the second adder 642 performs the addition of the value stored in the second temporary register 622 and the value stored in the sixth temporary register 626. Actually, the addition result calculated by the second adder 642 during the second stage 52 is stored in the sixth register 626 during the fourth stage 54.

During the fifth stage 55, the first adder 641 performs the addition of the value stored in the third temporary register 623 and the value stored in the seventh temporary register 627. In parallel, the second adder 642 performs the addition of the value stored in the third temporary register 623 and the value stored in the sixth temporary register 626.

The methods illustrated in FIGS. 4 and 5 are applied to the calculation of a cumulative histogram based on eight histogram values. When the number of histogram values is higher, the number of additions to be performed in parallel during each calculation stage is higher. For example, for calculating a cumulative histogram based on 256 histogram values, the method of FIG. 4 would need 128 additions in parallel. If such methods are implemented by a circuit, the number of adders required is considerable, which may form a drawback because the adders cover a considerable silicon surface in the circuit.

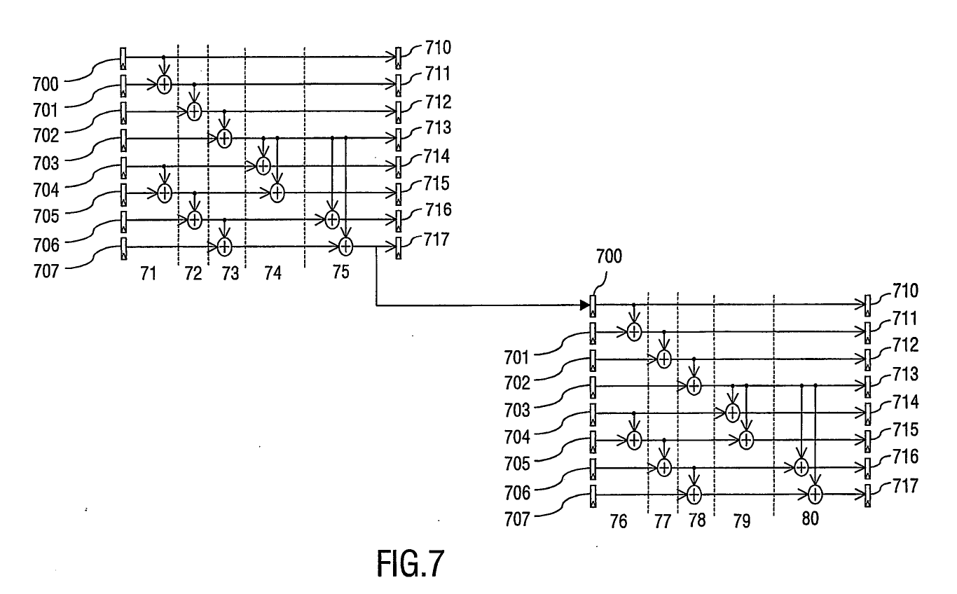

FIG. 7 illustrates a method according to an advantageous embodiment of the invention, which permits to mitigate this drawback. This method permits to calculate a cumulative histogram based on fifteen histogram values, in ten calculation stages, each calculation stage requiring only two additions in parallel. This method comprises two series of calculation stages, the first series comprising the stages 71 to 75, the second series the stages 76 to 80.

During a first stage 71, the histogram values that correspond to the pixel values 0 to 7 are loaded in eight registers 700 to 707. During five first stages 71 to 75, operations are carried out based on these values, said operations being identical to those carried out during the five stages 51 to 55 of the method illustrated in FIG. 5. This permits to obtain eight cumulative histogram values, which correspond to the pixel values 0 to 7. These eight cumulative histogram values, temporarily stored in eight registers 710 to 717, are then sent to a storage device not shown in FIG. 7.

During a sixth stage 76, the cumulative histogram value that corresponds to the pixel value 7 is sent to the register 700 and the histogram values that correspond to the pixel values 8 to 14 are loaded in the seven registers 701 to 707. During the stages 76 to 80, operations are carried out based on values stored in the registers 700 to 707, said operations being identical to those carried out during the five stages 51 to 55 of the method illustrated in FIG. 5. This permits to obtain seven cumulative histogram values, which correspond to the pixel values 8 to 14. These seven cumulative histogram values temporarily stored in the seven registers 711 to 717 are then sent to the storage device.

In a general way the number of pixel values in an image is a power of two. In the case where this power of pixel values is sixteen, that is to say, where the cumulative histogram is to be calculated based on sixteen histogram values, the method of FIG. 7 may easily be utilized. Actually, this method permits to calculate the fifteen first cumulative histogram values. In order to calculate the last cumulative histogram value, which corresponds to the pixel value 15, the cumulative histogram values stored in the register 717 during the stage 80 is sent to the register 700, and an additional stage is carried out, which corresponds to the first stage 51 of the method of FIG. 5.

This embodiment is particularly advantageous if the method according to the invention is implemented by a circuit. Actually, the method of FIG. 7 may be utilized by the circuit of FIG. 6. This circuit will then process a group of m histogram values, for example, a group of eight values, during a first series of calculation stages, and will then calculate the m first cumulative histogram values. Then the circuit will process groups of m-1 histogram values. In consequence, whatever the number of histogram values, this advantageous embodiment may be implemented by a circuit comprising a small number of adders, while, compared to the prior art, it reduces the required number of calculation stages. Moreover, a circuit utilizing the method according to this advantageous embodiment of the invention requires a limited number of temporary registers for storing the addition results. In effect, a series of calculation stages does not utilize the addition results calculated during previous series, but only a cumulative histogram value calculated during the previous series. Consequently, it is not necessary to back up the addition results during more than one series of calculation stages.

For example, a circuit shown in FIG. 6, implementing this advantageous embodiment of the invention, for calculating a cumulative histogram based on 256 histogram values, requires 5+5*35+3=173 calculation stages instead of 255 prior-art calculation stages.

As a matter of course it is also possible to apply the calculation stages of the method according to FIG. 4 successively to implement this advantageous embodiment of the invention. In this case the calculation of a cumulative histogram based on 256 histogram values requires 3+35*3+3=111 calculation stages. Such a method may be implemented by a circuit comprising only four adders.

It should be observed that a large number of methods such as given as examples in FIGS. 4, 5 and 7 may be envisaged according to the invention. For example, in order to calculate a cumulative histogram based on 256 histogram values, it is possible to carry out various series of calculation stages, the first series being intended to calculate the cumulative histogram values which correspond to the sixteen first histogram values, the second series to fifteen next values, the third series to the fifteen next values and so on and so forth. The calculation stages may utilize, for example, four additions in parallel.

A circuit as the one represented in FIG. 6 may be utilized in an image processing system intended to calculate pixel values for a display of these pixels on a screen. Such an image processing system may be incorporated, for example, in a decoder, a Set Top Box, a television, a central computer unit or a computer screen. Such an image processing system may be utilized in a communication network comprising at least a transmitter able to send signals representing at least one image, a transmission network, and a receiver able to receive said signals.

In principle it is possible to implement the method according to the invention by means of a suitably programmed integrated circuit. A set of instructions contained in a program memory may command the integrated circuit to carry out the various stages described earlier. The set of instructions may be loaded in the program memory by reading a data carrier such as, for example, a disc on which the set of instructions is coded. The reading may be effected via a communication network such as, for example, the Internet. In that case a service provider will render the set of instructions at the disposal of interested parties.

The verb “to comprise” and its conjugations are to be interpreted in a broad sense, that is to say, as not excluding the presence not only of other elements than those listed after said verb, but also of a plurality of elements already listed after said verb and preceded by the article “a” or “an”.

1. A method for processing images, implementing a calculation of cumulative histogram values based on N histogram values, said method being characterized in that it comprises calculation stages which use at least two parallel additions, each addition in a calculation stage leading to an addition result based on two histogram values or one histogram value and one addition result calculated during a previous calculation stage or two addition results calculated during at least one previous calculation stage.

2. A method for processing images as claimed in claim 1, characterized in that the calculation method comprises at least two successive series of calculation stages, each series of calculation stages being intended to calculate cumulative histogram values that correspond to a group of histogram values that includes a number of histogram values that is strictly lower than N.

3. A calculation circuit for calculating cumulative histogram values based on histogram values, said circuit comprising at least two adders able to perform additions in parallel during calculation stages, each addition during a calculation stage leading to an addition result based on two histogram values or one histogram value and on an addition result calculated during a preceding calculation stage or two addition results calculated during at least one preceding calculation stage.

4. An image processing system comprising a calculation circuit as claimed in claim 3.

5. A Set Top Box comprising at least an image processing system as claimed in claim 4.

6. A device comprising at least a screen intended to display images and an image processing system as claimed in claim 4.

7. A communication network comprising at least a transmitter able to send signals representing at least one image, a transmission network, a receiver able to receive said signals and an image processing system as claimed in claim 4.

8. A program comprising program code instructions for the execution of the stages of the method as claimed in claim 1 if said program is executed on a processor.
